(19) United States
(12) Patent Application Publication
(10) Pub. No.: US 2023/0297828 A1
(43) Pub. Date: Sep. 21, 2023

(54) SCORING MODEL LEARNING DEVICE, SCORING MODEL, AND DETERMINATION DEVICE

(71) Applicant: NTT DOCOMO, INC., Chiyoda-ku (JP)

(72) Inventors: Soichiro MURAKAMI, Chiyoda-ku (JP); Hosei MATSUOKA, Chiyoda-ku (JP)

(73) Assignee: NTT DOCOMO, INC., Chiyoda-ku (JP)

(21) Appl. No.: 17/766,668

(22) PCT Filed: Oct. 6, 2020
(86) PCT No.: PCT/JP2020/037873

§ 371 Date: Apr. 5, 2022

(30) Foreign Application Priority Data
Oct. 10, 2019 (JP) 2019-186842

(51) Int. Cl. G06N 3/08; G06N 3/044

(52) U.S. Cl. CPC G06N 3/08; G06N 3/044

(57) ABSTRACT

A scoring model learning device is a device that generates a scoring model for determining naturalness of an answer sentence to a question sentence, which outputs a likelihood of a label indicating naturalness of the answer sentence on the basis of a context vector, and the device includes a division unit that divides a concatenation sentence included in learning data including a pair of a concatenation sentence having a question sentence and an answer sentence concatenated with each other and a correct answer label indicating naturalness of the answer sentence into words to generate a word string, a prediction unit that inputs each word included in the word string to the scoring model according to an arrangement order and acquires a likelihood, and a model learning unit that updates parameters of the scoring model on the basis of an error between the acquired likelihood and the correct answer label.

### TECHNICAL FIELD

The present invention relates to a scoring model learning device, a scoring model, and a determination device.

### BACKGROUND ART

There is a technology for determining a degree of establishment of a sentence using a language model configured as a probability model for imparting a probability to a sentence including a word string. Further, a technology for estimating a dialogue action corresponding to a first utterance sentence using learning data including a first utterance sentence at a first time and a second utterance sentence at a time before the first time is known for the purpose of estimating a dialogue action using a model (see, for example, Patent Literature 1).

### CITATION LIST

### Patent Literature

[Patent Literature 1] Japanese Unexamined Patent Publication No. 2018-25747

### SUMMARY OF INVENTION

### Technical Problem

It is required to determine whether an answer to an open question is a natural answer to the question. Here, the natural answer refers to an answer having a good contextual connection to content of the question. For example, since a natural answer example with respect to a question is assumed when the question is preset, an answer example is prepared in advance and naturalness of an answer can be determined on the basis of a difference between an answer input with respect to a question and the answer example. However, it is not easy to determine naturalness of a free answer input with respect to an open question.

Therefore, the present invention has been made in view of the above problem, and an object thereof is to determine naturalness of an answer to an open question.

### Solution to Problem

In order to solve the above problem, a scoring model learning device according to an aspect of the present invention is a scoring model learning device for generating a scoring model for determining naturalness of an answer sentence to a question sentence through machine learning, wherein the scoring model includes a recurrent neural network, a context vector generation unit configured to synthesize hidden vectors output by a hidden layer in respective time steps of the recurrent neural network to generate a context vector, and a likelihood calculation unit configured to calculate a likelihood of a label indicating at least naturalness of the answer sentence to the question sentence on the basis of the context vector, and the scoring model learning device includes a division unit configured to divide a concatenation sentence included in learning data including a pair of a concatenation sentence having the question sentence and the answer sentence concatenated with each other and a correct answer label indicating naturalness as an answer to the question sentence of the answer sentence into words to generate a word string; a prediction unit configured to input each word included in the word string to the recurrent neural network of the scoring model according to an arrangement order and acquire the likelihood calculated by the likelihood calculation unit; and a model learning unit configured to update parameters of the recurrent neural network on the basis of an error between the likelihood acquired by the prediction unit and the correct answer label.

According to the above aspect, the scoring model is configured to include the recurrent neural network, the context vector generation unit, and the likelihood calculation unit. Learning of the scoring model is performed by updating the parameters of the recurrent neural network on the basis of an error between the likelihood obtained by inputting the word string obtained from the concatenation sentence having the question sentence and the answer sentence concatenated with each other to the recurrent neural network according to an arrangement order, and a correct answer label associated with the concatenation sentence as learning data. Since the context vector is generated by synthesizing the hidden vectors output in the respective time steps of the recurrent neural network, characteristics of the context of the concatenation sentence are indicated in the context vector. Since a connection between the question sentence and the answer sentence is included in the context of the concatenation sentence, characteristics of a connection between a question and an answer are also indicated in the context vector. Since the recurrent neural network is updated and learned on the basis of an error between a classification of naturalness or unnaturalness and a likelihood corresponding to the classification of such a context vector and the correct answer label indicating the naturalness, a scoring model that accurately determines the naturalness of the answer sentence is generated.

### Advantageous Effects of Invention

A scoring model learning device, a scoring model, and a determination device capable of judging naturalness of an answer to an open question are realized.

### BRIEF DESCRIPTION OF DRAWINGS

FIG. 1 is a block diagram illustrating a functional configuration of a scoring model learning device of the present embodiment.

FIG. 2 is a block diagram illustrating a functional configuration of a determination device of the present embodiment.

FIG. 3 is a hard block diagram of the scoring model learning device and the determination device.

FIG. 4 is a diagram illustrating an overview of a system realized in the scoring model learning device and the determination device of the present embodiment.

FIG. 5 is a diagram illustrating an example of learning data including a pair of a concatenation sentence and a correct answer label.

FIG. 6 is a diagram schematically illustrating a configuration of a recurrent neural network.

FIG. 7 is a diagram illustrating a configuration of a scoring model.

FIG. 8 is a diagram illustrating a configuration of a bidirectional recurrent neural network.

FIG. 9 is a diagram schematically illustrating an example of updating of parameters of a hidden layer based on an error between a hidden vector obtained by inputting an m-th word to the hidden layer and an (m+1)-th word arranged next to the m-th word in a word string.

FIG. 10 is a flowchart illustrating processing content of a scoring model learning method in the scoring model learning device.

FIG. 11 is a flowchart illustrating processing content of a determination method in a determination device.

FIG. 12(A) is a diagram illustrating a configuration of a scoring model learning program.

FIG. 12(B) is a diagram illustrating a configuration of a determination program.

### DESCRIPTION OF EMBODIMENTS

Embodiments of a scoring model learning device, a determination device, and a scoring model according to the present invention will be described with reference to the drawings. If possible, the same parts will be denoted by the same reference signs, and repeated description will be omitted.

The scoring model learning device, the determination device, and the scoring model of the present embodiment relate to a technology for determining whether or not an answer sentence input by a user is natural with respect to a question sentence presented by a system. Here, “natural” is a good contextual connection between the question sentence and the answer sentence.

Hereinafter, an example in which a contextual connection between a question sentence and an answer sentence is natural and an example in which the contextual connection is unnatural are shown.
(Example of natural answer sentence)
Question: What kind of music do you like?
Answer: I like classical music.
(Example of unnatural answer sentence)
Question: What kind of music do you like?
Answer: I like to play baseball.

In the example of the natural answer sentence, an answer in an answer sentence to a question sentence “favorite music” is “classical music”, which is contextually natural. On the other hand, in the example of the unnatural answer sentence, an answer in the answer sentence to the same question is “play baseball”, which is contextually unnatural.

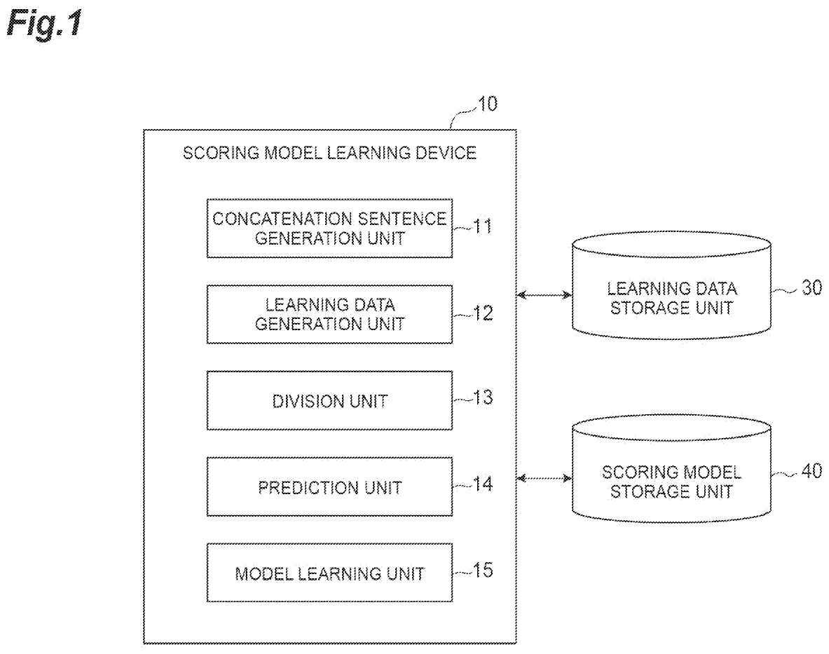

FIG. 1 is a diagram illustrating a functional configuration of a scoring model learning device according to the present embodiment. The scoring model learning device 10 is a device that generates a scoring model for determining the naturalness of an answer sentence to a question sentence through machine learning. As illustrated in FIG. 1, the scoring model learning device 10 functionally includes a concatenation sentence generation unit 11, a learning data generation unit 12, a division unit 13, a prediction unit 14, and a model learning unit 15. Each of these functional units 11 to 15 may be configured in one device or may be distributed and configured in a plurality of devices.

Further, the scoring model learning device 10 is configured to be accessible to a storage means such as a learning data storage unit 30 and the scoring model storage unit 40. The learning data storage unit 30 and the scoring model storage unit 40 may be configured in the scoring model learning device 10 or may be configured as separate devices outside the scoring model learning device 10, as illustrated in FIG. 1.

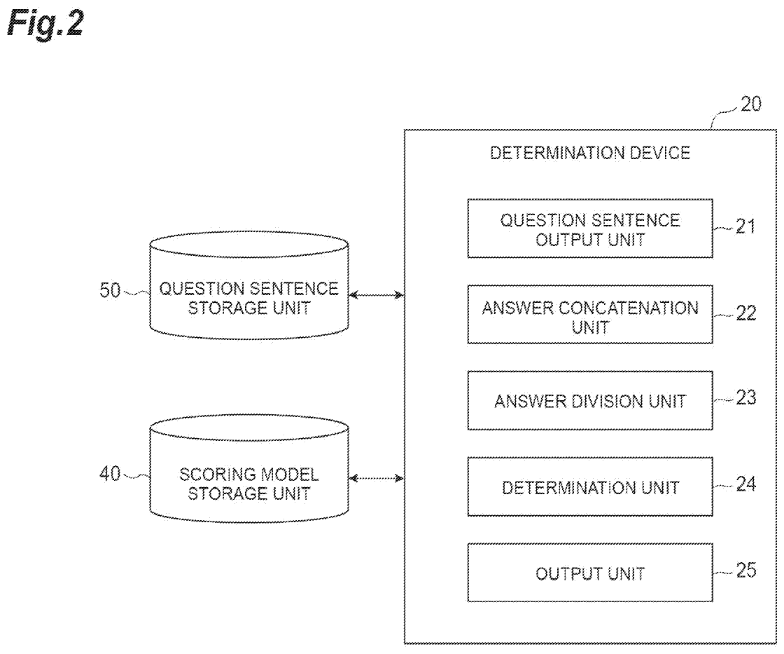

FIG. 2 is a diagram illustrating a functional configuration of the determination device according to the present embodiment. The determination device 20 is a device that determines naturalness of an answer sentence to a question sentence using the scoring model. As illustrated in FIG. 2, the determination device 20 functionally includes a question sentence output unit 21, an answer concatenation unit 22, an answer division unit 23, a determination unit 24, and an output unit 25. The functional units 21 to 25 may be configured in one device or may be distributed and configured in a plurality of devices.

Further, the determination device 20 is configured to be accessible to the scoring model storage unit 40 and a question sentence storage unit 50. The question sentence storage unit 50 may be configured in the determination device 20 or may be configured in another external device.

Further, in the present embodiment, an example in which the scoring model learning device 10 and the determination device 20 are configured as separate devices (computers) is shown, but these may be configured integrally.

The block diagrams illustrated in FIGS. 1 and 2 show blocks in units of functions. These functional blocks (constituent units) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto. For example, a functional block (a component) that functions for transmission is referred to as a transmitting unit or a transmitter. In any case, a realizing method is not particularly limited, as described above.

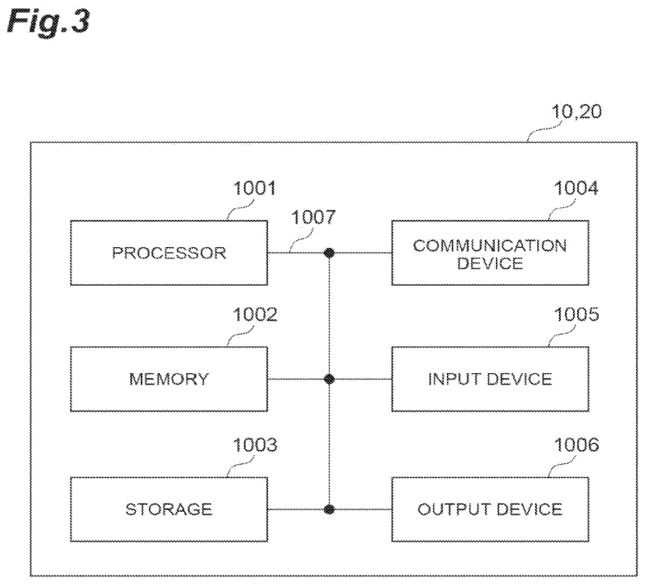

For example, the scoring model learning device 10 and the determination device 20 in an embodiment of the present invention may function as a computer. FIG. 3 is a diagram illustrating an example of a hardware configuration of the scoring model learning device 10 and the determination device 20 according to the present embodiment. Each of the scoring model learning device 10 and the determination device 20 may be physically configured as computer devices including a processor 1001, a memory 1002, a storage 1003, a communication device 1004, an input device 1005, an output device 1006, a bus 1007, and the like.

In the following description, a word “device” can be read as a circuit, device, unit, or the like. The hardware configuration of the scoring model learning device 10 and the determination device 20 may be configured to include one or more of the devices illustrated in FIG. 3 or may be configured not to include some of the devices.

Respective functions of the scoring model learning device 10 and the determination device 20 are realized when predetermined software (program) on hardware such as the processor 1001 and the memory 1002 is loaded and the processor 1001 performs calculation to control communication using the communication device 1004 and reading and/or writing of data in the memory 1002 and the storage 1003.

The processor 1001 operates, for example, an operating system to control the entire computer. The processor 1001 may be configured of a central processing unit (CPU) including an interface with peripheral devices, a control device, a calculation unit, a register, and the like. For example, the respective functional units 11 to 15 and 21 to 25 illustrated in FIGS. 1 and 2 may be realized by the processor 1001.

Further, the processor 1001 reads a program (program code), a software module, or data from the storage 1003 and/or the communication device 1004 into the memory 1002, and executes various processes according to the program, the software module, or the data. As the program, a program that causes a computer to execute at least some of operations described in the above-described embodiment is used. For example, the respective functional units 11 to 15 and 21 to 25 of the scoring model learning device 10 and the determination device 20 may be stored in the memory 1002 and realized by a control program operated by the processor 1001. Although a case in which the various processes described above are executed by one processor 1001 has been described, the processes may be executed simultaneously or sequentially by two or more processors 1001. The processor 1001 may be mounted on one or more chips. The program may be transmitted from a network via a telecommunication line.

The memory 1002 is a computer-readable recording medium, and may be configured of at least one of a read only memory (ROM), an erasable programmable ROM (EPROM), an electrically erasable programmable ROM (EEPROM), and a random access memory (RAM). The memory 1002 may also be referred to as a register, a cache, a main memory (main storage device), or the like. The memory 1002 can store a program (program code), a software module, or the like that can be executed to implement the scoring model learning method and the determination method according to an embodiment of the present invention.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including the memory 1002 and/or the storage 1003, a server, or another appropriate medium.

The communication device 1004 is hardware (a transmission and reception device) for performing communication between computers via a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 or the memory 1002 is connected by the bus 1007 for communicating information. The bus 1007 may be configured of a single bus or may be configured of different buses between devices.

The scoring model learning device 10 and the determination device 20 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

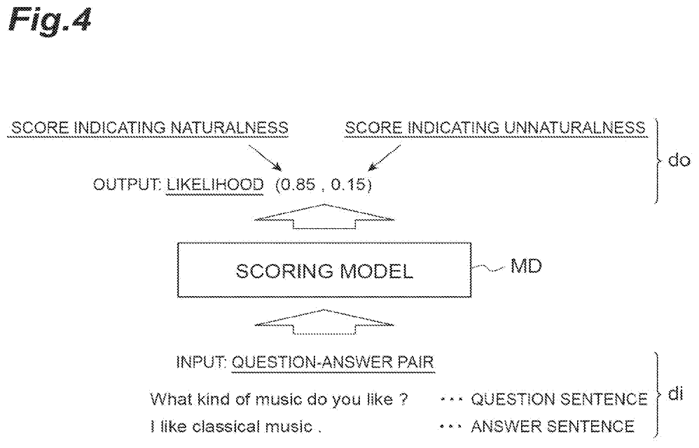

FIG. 4 is a diagram illustrating an overview of a system that is realized in the scoring model learning device and the determination device of the present embodiment. In the present embodiment, it is determined whether an answer sentence (“I like classical music.”) input by the user to a certain question sentence (“What kind of music do you like?”) presented by the system is natural or unnatural, using a scoring model MD constructed through machine learning, as illustrated in FIG. 4.

A question-answer pair di including a question sentence and an answer sentence is given as an input to the scoring model MD, and a score do (likelihood) indicating naturalness/unnaturalness of the question-answer pair is output. In the present embodiment, learning of the scoring model is first performed using the learning data including the question sentence and the answer sentence in a learning phase, and it is determined as to whether or not the answer sentence input by the user to the presented question sentence is natural in a prediction phase.

Next, each functional unit of the scoring model learning device 10 will be described. The concatenation sentence generation unit 11 concatenates the question sentence with the answer sentence to the question sentence to generate a concatenation sentence. The learning data generation unit 12 generates learning data including a pair of the concatenation sentence and a correct answer label indicating the naturalness as an answer to the question sentence of the answer sentence included in the concatenation sentence. The generation of the concatenation sentence and the generation of learning data will be specifically described below.

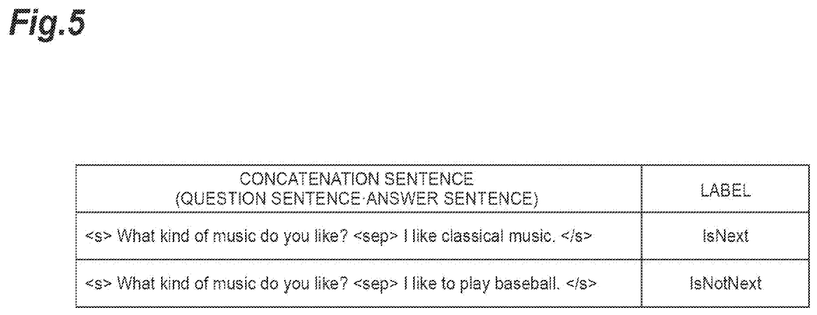

FIG. 5 is a diagram illustrating an example of learning data including a pair of a concatenation sentence and a correct answer label. The concatenation sentence generation unit 11 acquires a pair of a question sentence and an answer sentence from, for example, the learning data storage unit 30. The learning data storage unit 30 is a storage means that stores data that is used for machine learning of a scoring model and stores, for example, a question sentence and an answer sentence corresponding to the question sentence in association with each other.

The concatenation sentence generation unit 11 acquires a question sentence “What kind of music do you like?” and a corresponding answer sentence “I like classical music.” and concatenates the question sentence with the answer sentence to generate a concatenation sentence “What kind of music do you like? I like classical music.”.

The concatenation sentence generation unit 11 may generate the concatenation sentence by inserting a delimiter token (for example, <sep>) indicating a delimiter of a sentence between the question sentence and the answer sentence in the generation of the concatenation sentence. Further, the concatenation sentence generation unit 11 may insert a start token (for example, <s>) indicating start of the sentence and an end token (for example, <s>) indicating end of the sentence to generate the concatenation sentence “<s>What kind of music do you like?<sep>I like classical music.</S>.

The learning data generation unit 12 associates a natural label “IsNext” indicating that the answer sentence is natural, with a concatenation sentence as learning data of a positive example to generate learning data of a positive example, as shown in an example of learning data in an upper part of a table illustrated in FIG. 5. Further, since the answer sentence “I like to play baseball.” in the example of the learning data at a lower part of the table illustrated in FIG. 5 is not a natural answer to the question sentence “What kind of music do you like?”, the learning data generation unit 12 associates the unnatural label “IsNotNext” indicating that the answer sentence is unnatural with the concatenation sentence “<s>What kind of music do you like?<sep>I like to play baseball.</s>” to generate learning data of a negative example.

The concatenation sentence in the learning data created in this way is treated as one sentence when the concatenation sentence is input to the scoring model. The learning data generation unit 12 may store the generated learning data in the learning data storage unit 30.

The division unit 13 divides the concatenation sentence included in the learning data into words to generate a word string. Specifically, the division unit 13 generates a word string on the basis of the concatenation sentence included in the learning data acquired from the learning data generation unit 12 or the learning data storage unit 30. The learning data storage unit 30 is not limited to the learning data generated by the learning data generation unit 12, but may store learning data prepared in advance.

When the division unit 13 acquires, for example, a concatenation sentence “<s>What kind of music do you like?<sep>I like classical music.</s>” as learning data, the division unit 13 generates a word string “<s>, What, kind, of, music, do, you, like, ?, <sep>, I, like, classical, music, ., </s>”.

The prediction unit 14 inputs the words included in the word string based on the concatenation sentence of the learning data to the scoring model according to an arrangement order, and acquires a likelihood for each correct answer label output from the scoring model. That is, the word string constituting the concatenation sentence having the question sentence and the answer sentence concatenated with each other is input to the scoring model, and a likelihood for each of a natural label (IsNext) indicating that a pair of a question sentence and an answer sentence input to the scoring model is natural an unnatural label (IsNotNext) indicating that the pair is unnatural is output from the scoring model.

The scoring model includes a recurrent neural network, a context vector generation unit that synthesizes hidden vectors output by a hidden layer at respective time steps of the recurrent neural network to generate a context vector, and a likelihood calculation unit that calculates a likelihood for a label indicating at least naturalness of an answer sentence to a question sentence on the basis of the context vector.

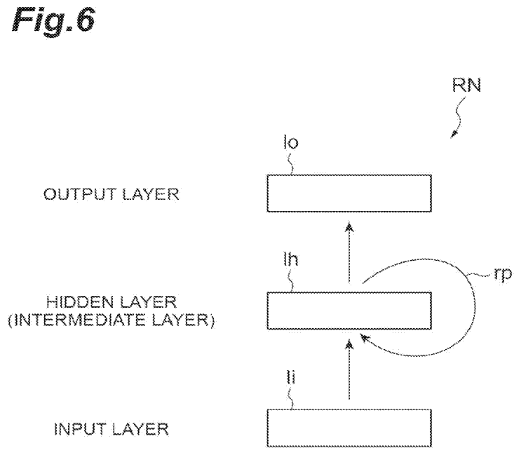

The recurrent neural network is a neural network extended to handle variable-length continuous information (for example, time-series information). FIG. 6 is a diagram illustrating a configuration of the recurrent neural network. The recurrent neural network RN includes an input layer li, a hidden layer (intermediate layer) lh, and an output layer lo, as illustrated in FIG. 6.

An input vector of a current time step is input to the input layer li. The hidden layer lh calculates a hidden vector on the basis of, for example, the input vector input to the input layer li. The hidden layer lh has a recurrent structure rp for using the hidden vector calculated in a previous time step for the calculation of the hidden vector in the current time step. Therefore, the hidden layer lh calculates the hidden vector in the current time step on the basis of the input vector in the current time step and the hidden vector calculated in the previous time step. The output layer lo outputs the hidden vector calculated by the hidden layer lh.

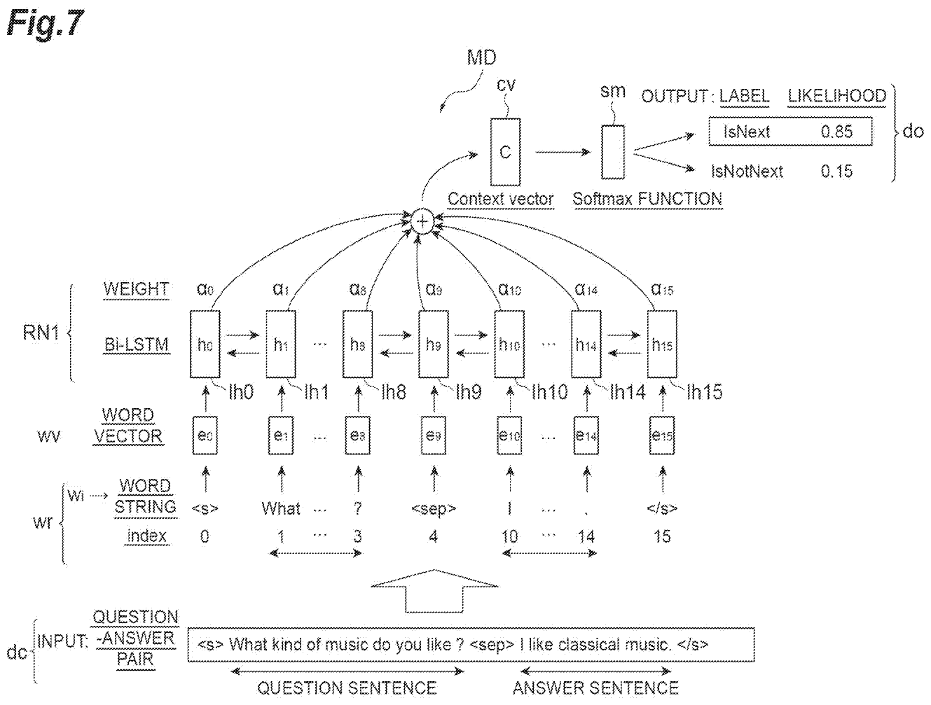

FIG. 7 is a diagram illustrating a configuration of the scoring model. As illustrated in FIG. 7, the scoring model MD includes a recurrent neural network RN1, a context vector generation unit cv, and a likelihood calculation unit sm. In FIG. 7, the recurrent neural network RN1 is developed and shown in each time step.

The division unit 13 acquires a concatenation sentence dc generated on the basis of the question-answer pair which is a pair of a question sentence and an answer sentence, and divides the acquired concatenation sentence dc into words to generate a word string wr.

The prediction unit 14 generates a word vector eᵢ as shown in Equation (1) on the basis of a word wᵢ (i indicates an index and corresponds to a time step) included in the word string wr.

[Equation 1]

eᵢ=Embedding(wᵢ) (1)

The word vector eᵢ is a vector having a number of dimensions corresponding to the number of vocabularies handled by the scoring model. Accordingly, a word vector sequence wv, which is a sequence of word vector eᵢ, is generated.

The prediction unit 14 inputs the word vector eᵢ included in the word vector series wv to the input layer of the recurrent neural network RN1 according to an arrangement order. A hidden layer lhᵢ outputs a hidden vector hᵢ on the basis of the input word vector eᵢ. The calculation in the hidden layer lhᵢ is expressed by, for example, Equation (2) below.

[Equation 2])

hᵢ=f(eᵢ,hᵢ₋₁) (2)

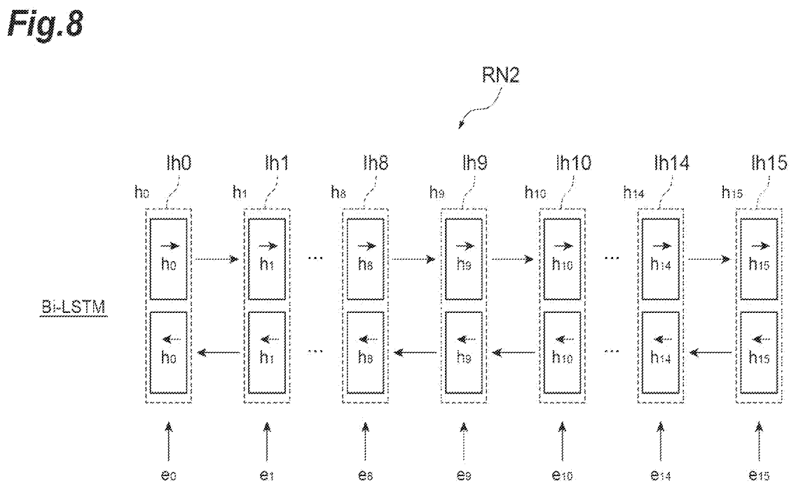

This equation (2) is applied when the recurrent neural network RN1 is a unidirectional type. An example of calculation of a hidden vector when the scoring model MD is configured of a bidirectional recurrent neural network as illustrated in FIG. 7 will be described below with reference to FIG. 8.

The prediction unit 14 causes the context vector generation unit cv to synthesize the hidden vector hᵢ output by the hidden layer lh in each time step to generate the context vector c. Specifically, the prediction unit 14 causes the context vector generation unit cv to generate the context vector c using Equation (3).

$$[ Equation 3 ]$$

$$c = {\sum }_{i = 0}^{n - 1} {α}_{i} {h}_{i} \qquad ( 3 )$$

αᵢ in Equation (3) is a weight for each hidden vector hᵢ, and the weight is αᵢ caution weight vector indicating importance of the hidden vector hᵢ in each time step and is calculated using a softmax function, as illustrated in Equation (4) below.

$$[ Equation 4 ]$$

$${α}_{i} = \frac{exp ( {s}_{i} )}{{\sum }_{k = 0}^{n - 1} exp ( {s}_{k} )} \qquad ( 4 )$$

Sᵢ in Equation (4) is represented by Equation (5).

[Equation 5]

sᵢ=a(hᵢ) (5)

a in Equation (5) is a function for calculating the importance of the hidden vector hᵢ and includes, for example, a forward neural network, and the parameters constituting the neural network are updated at the time of learning. Accordingly, as a result, the weight αᵢ is also updated at the time of learning of the scoring model.

The prediction unit 14 causes the likelihood calculation unit sm to calculate a likelihood do for each of a natural label (IsNext) indicating that the pair of the question sentence and the answer sentence input to the scoring model MD is natural and an unnatural label (IsNotNext) indicating that the pair is unnatural, on the basis of the context vector c. The likelihood calculation unit sin is configured of, for example, a softmax function. Therefore, the prediction unit 14 causes the likelihood calculation unit sm to calculate the likelihood do for each of the natural label (IsNext) and the unnatural label (IsNotNext) using the softmax function constituting the likelihood calculation unit sin.

The model learning unit 15 updates parameters of the recurrent neural network RN1 on the basis of the error between the likelihood do acquired by the prediction unit 14 and the correct answer label. The parameters to be updated here can include parameters for generation of the weight αᵢ, in addition to parameters of the hidden layer or the like of the recurrent neural network RN1. The model learning unit 15 can update the parameters using, for example, a well-known error back propagation method.

The model learning unit 15 may store the scoring model MD obtained after machine learning based on a required amount of learning data in the scoring model storage unit 40. The scoring model storage unit 40 is a storage means for storing the learned scoring model MD. The scoring model MD stored in the scoring model storage unit 40 is used for determination processing in the determination device 20.

As described above, the recurrent neural network included in the scoring model MD may be a bidirectional recurrent neural network. FIG. 8 is a diagram illustrating the bidirectional recurrent neural network. In the bidirectional recurrent neural network RN2 illustrated in FIG. 8, the hidden layer lh outputs a hidden vector in an n-th (n is an integer equal to or greater than 2) time step on the basis of a word input in the n-th time step, a hidden vector output in an (n+1)-th time step, and a hidden vector output in an (n−1)-th time step, in the n-th time step.

Specifically, the hidden layer lh outputs a forward hidden vector in a time step i on the basis of the word vector eᵢ including the words input in the time step i and a hidden vector hᵢ₋₁ generated in a time step (i−1), as shown in Equation (6).

[Equation 6]

\vec{h}ᵢ=f(eᵢ,\vec{h}ᵢ₋₁) (6)

Further, the hidden layer lh outputs a backward hidden vector in the time step i on the basis of the word vector eᵢ including the words input in the time step i and a hidden vector hᵢ₊₁ generated in a time step (i+1), as shown in Equation (7).

[Equation 7]

[symbol]

=f(eᵢ, [symbol] ) (7)

The hidden layer lh combines the forward hidden vector with the backward hidden vector to output the hidden vector hᵢ in the time step i, as shown in Equation (8).

[Equation 8]

hᵢ=[\vec{h}ᵢ; [symbol] (8)

Further, the model learning unit 15 can impart not only a classification task for determining the naturalness of the answer sentence, but also an aspect as a language model task to the scoring model in order to configure a scoring model in which fluency of an answer sentence input by the user can be considered.

Specifically, the model learning unit 15 updates the parameters of the hidden layer of the recurrent neural network on the basis of an error between a word predicted on the basis of the hidden vector obtained by inputting an m-th word wₘ among the plurality of word wᵢ included in the word string wr to the hidden layer of the recurrent neural network and a (m+1)-th word wₘ₊₁, which is a word next to the m-th word in the word string wr, in the time step of the m-th (m is an integer equal to or greater than 2).

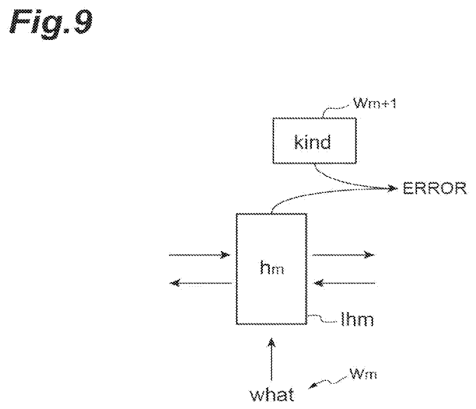

FIG. 9 is a diagram schematically illustrating an example of updating of the parameters of the hidden layer based on an error between the hidden vector obtained by inputting the m-th word to the hidden layer and the (m+1)-th word arranged next to the m-th word in the word string. The model learning unit 15 inputs the word wₘ to a hidden layer lhm to obtain the hidden vector hₘ in a time step “m”. The model learning unit 15 updates the parameters of the recurrent neural network (the hidden layer) so that the error is minimized on the basis of an error between the word predicted on the basis of the hidden vector hₘ and a word wₘ₊₁, which is a word next to the word wₘ in the word string wr. That is, the model learning unit 15 can update the parameters of the recurrent neural network using not only a prediction error of the label as a document classification task but also a prediction error of a next word as the language model task.

The recurrent neural network constituting the scoring model MD of the present embodiment may be a long short term memory (LSTM) network or a gated recurrent unit (GRU) network. It becomes possible to construct a scoring model in which a connection of a longer word string is considered, by configuring the recurrent neural network using the LSTM network or the GRU network.

The scoring model MD, which is a model including a learned neural network, can be regarded as a program that is read or referred to by a computer, causes the computer to execute predetermined processing, and causes the computer to realize a predetermined function.

That is, the learned scoring model MD of the present embodiment is used in a computer including a CPU and a memory. Specifically, the CPU of the computer performs calculation based on a learned weighting coefficient (parameter) corresponding to each layer, a response function, or the like on the input data input to the input layer of the neural network according to a command from the learned scoring model MD stored in the memory, and operates to output a result (likelihood) from the output layer.

Next, functional units of the determination device 20 and the question sentence storage unit 50 will be described with reference to FIG. 2. The question sentence storage unit 50 is a storage means that stores the question sentence presented to the user. The question sentence output unit 21 acquires, for example, the question sentence stored in the question sentence storage unit 50 and presents the question sentence to the user. The presentation of the question sentence to the user can be, for example, a display using a predetermined display device and an output using voice.

The answer concatenation unit 22 concatenates the answer sentence input by the user with respect to the question sentence and the question sentence to generate a concatenated answer sentence. The generation of the concatenated answer sentence is performed in the scoring model learning device 10 like the generation of the concatenation sentence in the concatenation sentence generation unit 11.

The answer division unit 23 divides the concatenated answer sentence generated by the answer concatenation unit into words to generate an answer word string including a word string. The generation of the answer word string through the division of the concatenated answer sentence is performed like the generation of the word string in the division unit 13 of the scoring model learning device 10.

The determination unit 24 inputs the answer word string to the learned scoring model MD, and acquires the likelihood indicating at least the naturalness of the answer sentence. Specifically, the determination unit 24 acquires a likelihood for each of a natural label (IsNext) indicating that a pair of a question sentence input to the scoring model and an answer sentence input by the user is natural, and an unnatural label (IsNotNext) indicating that the pair is unnatural, from an output of the scoring model MD.

The output unit 25 outputs a determination result based on the likelihood acquired by the determination unit 24. Specifically, the output unit 25 may output a likelihood for each of the natural label (IsNext) and the unnatural label (IsNotNext) as a determination result. Further, the output unit 25 may output a determination result as to whether or not the answer input by the user is natural on the basis of a comparison between the acquired likelihood and a predetermined threshold value. Further, the output unit 25 may calculate a score indicating the naturalness of the answer on the basis of the acquired likelihood and output the calculated score. The output of the determination result can be, for example, a display using a predetermined display device or an output using voice.

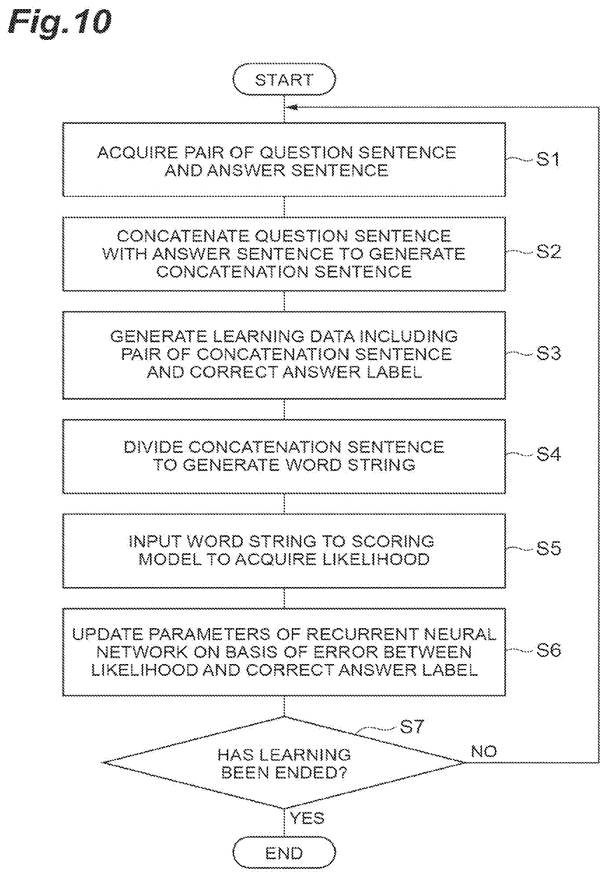

FIG. 10 is a flowchart illustrating processing content of a scoring model learning method in the scoring model learning device 10.

In step S1, the concatenation sentence generation unit 11 acquires a pair of a question sentence and an answer sentence from, for example, the learning data storage unit 30.

In step S2, the concatenation sentence generation unit 11 concatenates the question sentence with the answer sentence to generate a concatenation sentence.

In step S3, the learning data generation unit 12 generates learning data including a pair of the concatenation sentence and the correct answer label (for example, a natural label (IsNext) or an unnatural label (IsNotNext)) indicating the naturalness as the answer to the question sentence of the answer sentence included in the concatenation sentence.

In step S4, the division unit 13 divides the concatenation sentence included in the learning data into words to generate a word string.

In step S5, the prediction unit 14 inputs each word included in the word string based on the concatenation sentence of the learning data to the scoring model MD according to an arrangement order, and acquires the likelihood for each correct answer label output from the scoring model.

In step S6, the model learning unit 15 updates the parameters of the recurrent neural network RN on the basis of the error between the likelihood acquired by the prediction unit 14 in step S5 and the correct answer label.

In step S7, the scoring model learning device 10 determines whether or not a predetermined learning ending condition is satisfied, and repeats learning processing of steps S1 to S6 until the learning ending condition is satisfied. The learning ending condition is, for example, that learning with a predetermined number of learning pieces of data has ended, and is not limited thereto.

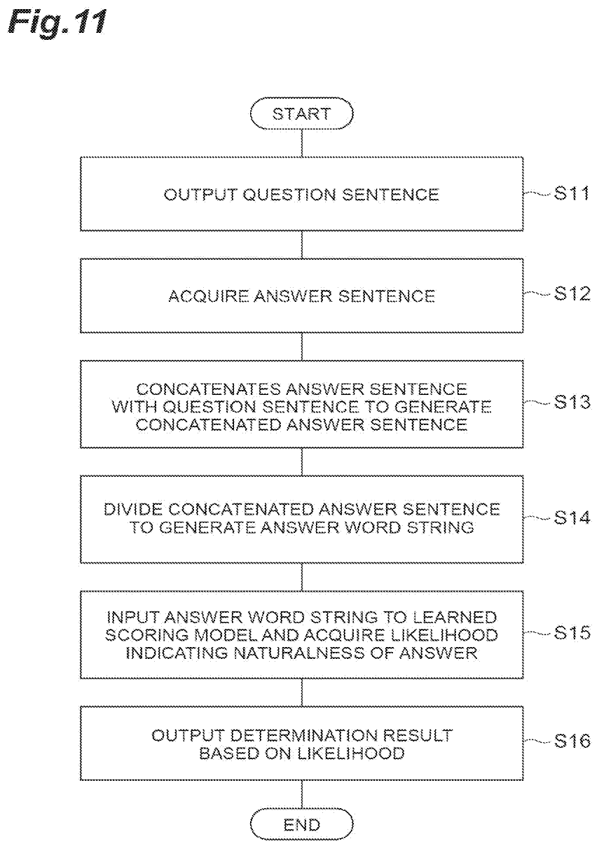

FIG. 11 is a flowchart illustrating processing content of a determination method using the learned scoring model MD in the determination device 20.

In step S11, the question sentence output unit 21 acquires, for example, the question sentence stored in the question sentence storage unit 50 and outputs the question sentence to present the question sentence to the user. An output of the question sentence is, for example, a display using a predetermined display device, and an output using voice.

In step S12, the answer concatenation unit 22 acquires the answer sentence input by the user. In step S13, the answer concatenation unit 22 concatenates the answer sentence input by the user with respect to the question sentence and the question sentence to generate a concatenated answer sentence.

In step S14, the answer division unit 23 divides the concatenated answer sentence generated by the answer concatenation unit into words to generate an answer word string including a word string.

In step S15, the determination unit 24 inputs the answer word string to the learned scoring model MD, and acquires the likelihood indicating at least the naturalness of the answer sentence. Specifically, the determination unit 24 acquires the likelihood for each of the natural label (IsNext) indicating that a pair of a question sentence and an answer sentence input by the user is natural, and the unnatural label (IsNotNext) indicating that the pair is unnatural, from the output of the scoring model MD.

In step S16, the output unit 25 outputs a determination result based on the likelihood acquired by the determination unit 24. The output of the determination result can be, for example, a display using a predetermined display device or an output using voice.

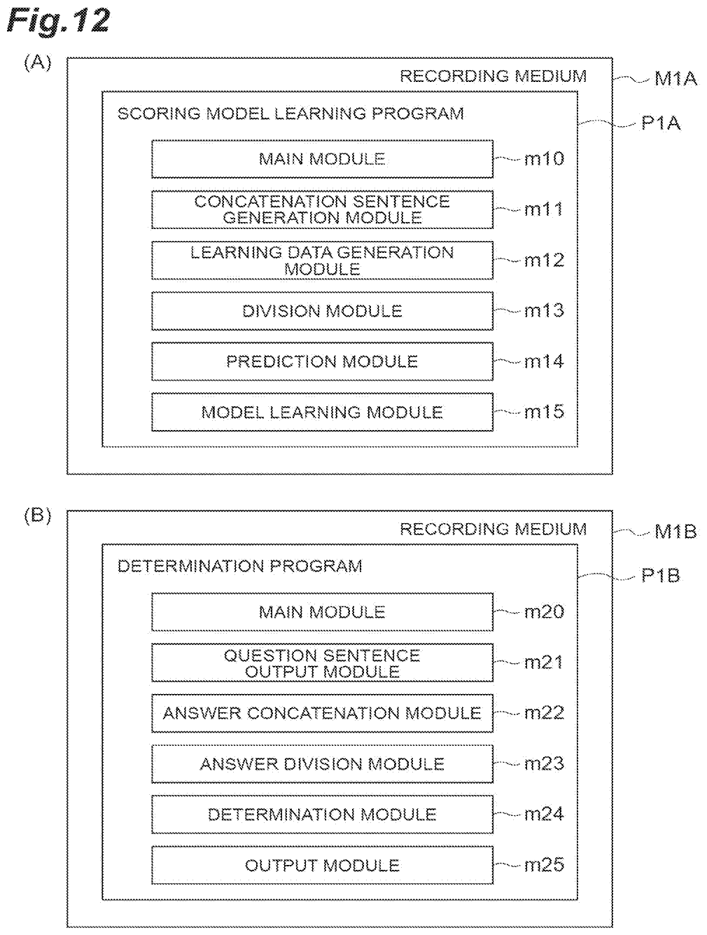

Next, a scoring model learning program for causing a computer to function as the scoring model learning device 10 of the present embodiment and a determination program for causing the computer to function as the determination device 20 will be described with reference to FIG. 12.

FIG. 12(A) is a diagram illustrating a configuration of the scoring model learning program. A scoring model learning program P1A includes a main module m10, a concatenation sentence generation module m11, a learning data generation module m12, a division module m13, a prediction module m14, and a model learning module m15 that comprehensively control scoring model learning processing in the scoring model learning device 10. Respective functions for the concatenation sentence generation unit 11, the learning data generation unit 12, the division unit 13, the prediction unit 14, and the model learning unit 15 are realized by the respective modules m11 to m15.

The scoring model learning program P1A may be an aspect that is transmitted via a transmission medium such as a communication line, or may be an aspect that is stored in a recording medium M1A as illustrated in FIG. 12(A).

FIG. 12(B) is a diagram illustrating a configuration of the determination program. A determination program P1B includes a main module m20, a question sentence output module m21, an answer concatenation module m22, an answer division module m23, a determination module m24, and an output module m25 that comprehensively control the determination processing in the determination device 20. Respective functions for the question sentence output unit 21, the answer concatenation unit 22, the answer division unit 23, the determination unit 24, and the output unit 25 are realized by the respective modules m21 to m25.

The determination program P1B may be an aspect that is transmitted via a transmission medium such as a communication line, or may be an aspect that is stored in a recording medium M1B as illustrated in FIG. 12(B).

According to the scoring model learning device 10, the scoring model learning method, the determination device 20, the determination method, the scoring model MD, the scoring model learning program P1A, and the determination program P1B of the present embodiment described above, the scoring model MD includes the recurrent neural network, the context vector generation unit, and the likelihood calculation unit. Learning of the scoring model is performed by updating the parameters of the recurrent neural network on the basis of an error between a likelihood obtained by inputting the word string obtained from the concatenation sentence having the question sentence and the answer sentence concatenated with each other to the recurrent neural network according to an arrangement order, and a correct answer label associated with the concatenation sentence as learning data. Since the context vector is generated by synthesizing the hidden vectors output in the respective time steps of the recurrent neural network, characteristics of the context of the concatenation sentence are indicated in the context vector. Since a connection between the question sentence and the answer sentence is included in the context of the concatenation sentence, characteristics of a connection between a question and an answer are also indicated in the context vector. Since the recurrent neural network is updated and learned on the basis of an error between a classification of naturalness or unnaturalness and a likelihood corresponding to the classification of such a context vector and the correct answer label indicating the naturalness, a scoring model that accurately determines the naturalness of the answer sentence is generated. Further, such a generated scoring model makes it possible to accurately determine the naturalness of the answer to an open question.

In order to solve the above problem, a scoring model according to an aspect of the present invention is a learned scoring model based on machine learning for causing a computer to function to determine naturalness of an answer sentence to a question sentence, the learned scoring model including: a recurrent neural network; a context vector generation unit configured to synthesize hidden vectors output by a hidden layer in respective time steps of the recurrent neural network to generate a context vector; and a likelihood calculation unit configured to calculate a likelihood of a label indicating at least naturalness of the answer sentence to the question sentence on the basis of the context vector, wherein words in an arrangement order in a word string generated by dividing a concatenation sentence having the question sentence and the answer sentence concatenated with each other are used as inputs in each time step of the recurrent neural network, and the learned scoring model is constructed by machine learning for updating parameters of the recurrent neural network on the basis of an error between the likelihood calculated by the likelihood calculation unit by using a pair of a concatenation sentence and a correct answer label indicating naturalness as an answer to the question sentence of the answer sentence included in the concatenation sentence as learning data and inputting the word string generated on the basis of the concatenation sentence included in the learning data to the recurrent neural network and the correct answer label included in the learning data.

In order to solve the above problem, a determination device according to an aspect of the present invention is a determination device for determining naturalness of an answer sentence with respect to a question sentence, the determination device including: an answer concatenation unit configured to concatenate the answer sentence input with respect to the question sentence with the question sentence to generate a concatenated answer sentence; an answer division unit configured to divide the concatenated answer sentence into words to generate an answer word string; a determination unit configured to input words included in the answer word string to a scoring model including a recurrent neural network in an arrangement order and acquire a likelihood indicating at least the naturalness of the answer sentence; and an output unit configured to output a determination result based on the likelihood acquired by the determination unit, wherein the scoring model is a learned model based on machine learning for causing a computer to function, and includes the recurrent neural network; a context vector generation unit configured to synthesize hidden vectors output by a hidden layer in respective time steps of the recurrent neural network to generate a context vector; and a likelihood calculation unit configured to calculate a likelihood of a label indicating at least naturalness of the answer sentence to the question sentence on the basis of the context vector, words in a word string generated by dividing a concatenation sentence having the question sentence and the answer sentence concatenated with each other are used as inputs in each time step of the recurrent neural network, and the scoring model is constructed by machine learning for updating parameters of the recurrent neural network on the basis of an error between the likelihood calculated by the likelihood calculation unit by using a pair of a concatenation sentence and a correct answer label indicating naturalness as an answer to the question sentence of the answer sentence included in the concatenation sentence as learning data and inputting the word string generated on the basis of the concatenation sentence included in the learning data to the recurrent neural network and the correct answer label included in the learning data.

According to the above aspect, the scoring model is configured to include the recurrent neural network, the context vector generation unit, and the likelihood calculation unit. Learning of the scoring model is performed by updating the parameters of the recurrent neural network on the basis of an error between the likelihood obtained by inputting the word string obtained from the concatenation sentence having the question sentence and the answer sentence concatenated with each other to the recurrent neural network according to an arrangement order, and a correct answer label associated with the concatenation sentence as learning data. Since the context vector is generated by synthesizing the hidden vectors output in the respective time steps of the recurrent neural network, the characteristics of the context of the concatenation sentence are indicated in the context vector. Since a connection between the question sentence and the answer sentence is included in the context of the concatenation sentence, characteristics of a connection between a question and an answer are also indicated in the context vector. Since the recurrent neural network is updated and learned on the basis of an error between a classification of naturalness or unnaturalness and a likelihood corresponding to the classification of such a context vector and the correct answer label indicating the naturalness, a scoring model that accurately determines the naturalness of the answer sentence is generated. Further, such a generated learned scoring model makes it possible to accurately determine the naturalness of the answer to the open question.

Further, the scoring model learning device according to another aspect may further include a concatenation sentence generation unit configured to concatenate the question sentence and the answer sentence to the question sentence to generate the concatenation sentence; and a learning data generation unit configured to generate the learning data including a pair of a concatenation sentence and a correct answer label indicating the naturalness as an answer to the question sentence of the answer sentence included in the concatenation sentence.

According to the above aspect, the concatenation sentence including a characteristic of the contextual connection between the question sentence and the answer sentence is generated, and learning data suitable for learning of the scoring model is generated.

Further, in the scoring model learning device according to another aspect, the concatenation sentence generation unit inserts a delimiter token indicating a delimiter of a sentence between the question sentence and the answer sentence to generate the concatenation sentence.

According to the above aspect, since the characteristic of the contextual connection between the question sentence and the answer sentence is included in the concatenation sentence input as the learning data, a boundary between the question sentence and the answer sentence is clearly shown in the context, and the learning of the scoring model is performed, it becomes possible to perform the determination of the naturalness of the answer sentence with higher accuracy.

Further, in the scoring model learning device according to another aspect, the context vector generation unit of the scoring model may weight and synthesize the hidden vectors output from the hidden layer in the respective time steps of the recurrent neural network to generate the context vector, and the model learning unit may update the parameters of the recurrent neural network and the weight on the basis of the error between the likelihood acquired by the prediction unit and the correct answer label.

According to the above aspect, since the context vector is generated by synthesizing the weighted hidden vectors indicating words that should be further noticed in the word string, a context vector reflecting contextual characteristics of the concatenation sentence more preferably is obtained. Therefore, it is possible to perform construction of the scoring model capable of determining the naturalness of the answer sentence with higher accuracy and determination of the naturalness of the answer sentence.

Further, in the scoring model learning device according to another aspect, the model learning unit may update the parameters of the hidden layer of the recurrent neural network on the basis of an error between a word predicted on the basis of a hidden vector obtained by inputting an m-th word among a plurality of words included in the word string to the hidden layer of the recurrent neural network and a (m+1)-th word that is a word next to the m-th word in the word string, in a m-th (in is an integer equal to or greater than 2) time step.

According to the above aspect, since the parameters of the hidden layer are updated and learned on the basis of an error between the hidden vector output from the hidden layer in each time step of the recurrent neural network and a word appearing in the word string next to the word input to the hidden layer in the time step, a scoring model capable of scoring in which not only the context of the concatenation sentence, but also fluency of the question sentence and the answer sentence is considered can be obtained.

Further, in the scoring model learning device according to another aspect, the recurrent neural network is a bidirectional recurrent neural network, the hidden layer may output a hidden vector in the n-th time step on the basis of a word input in an n-th (n is an integer equal to or greater than 2) time step, a hidden vector output in an (n+1)-th time step, and a hidden vector output in an (n−1)-th time step, in the n-th time step.

According to the above aspect, since the recurrent neural network is configured of a bidirectional recurrent neural network, a context based on a relationship between the word strings before and after the word input to the hidden layer in the time step is reflected in the hidden vector output from the hidden layer in each time step of the recurrent neural network. Therefore, a highly accurate determination of the naturalness of the answer sentence can be performed.

Further, in the scoring model learning device according to another aspect, the recurrent neural network may be a long short term memory (LSTM) network or a gated recurrent unit (GRU) network.

According to the above aspect, it becomes possible to construct a scoring model in which a connection of a longer word string is considered, by configuring the recurrent neural network using the LSTM network or the GRU network.

Further, in the scoring model learning device according to another aspect, the model learning unit may update the parameters of the hidden layer of the recurrent neural network on the basis of an error between a word predicted on the basis of a hidden vector obtained by inputting an m-th word among a plurality of words included in the word string to the hidden layer of the recurrent neural network and a (m+1)-th word that is a word next to the m-th word in the word string, in a m-th (in is an integer equal to or greater than 2) time step.

According to the above aspect, the recurrent neural network in which the parameters of the hidden layer have been updated and learned on the basis of the error between the hidden vector output from the hidden layer in each time step of the recurrent neural network and the word appearing in the word string next to the word input to the hidden layer in the time step, and the scoring model can be obtained. Therefore, scoring in which not only the context of the concatenation sentence, but also fluency of the question sentence and the answer sentence is considered can be performed.

Although the present embodiment has been described in detail above, it is apparent to those skilled in the art that the present embodiment is not limited to the embodiments described in the present specification. The present embodiment can be implemented as a modified and changed aspect without departing from the spirit and scope of the present invention defined by the description of the claims. Accordingly, the description of the present specification is intended for the purpose of illustration and does not have any restrictive meaning with respect to the present embodiments.

Each aspect or embodiment described in the present specification may be applied to long term evolution (LTE), LTE-Advanced (LTE-A), SUPER 3G, IMT-Advanced, 4G, 5G, future radio access (FRA), W-CDMA (registered trademark), GSM (registered trademark), CDMA2000, ultra mobile broad-band (UMB), IEEE 802.11 (Wi-Fi), IEEE 802.16 (WiMAX), IEEE 802.20, Ultra-Wide Band (UWB), Bluetooth (registered trademark), another system using an appropriate system, and/or a next generation system extended on the basis of these.

The processing procedure, sequence, flowchart, and the like in each aspect/embodiment described in the present specification may be in a different order unless inconsistency arises. For example, for the method described in the present specification, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present specification may be used alone, may be used in combination, or may be used by being switched according to execution. Further, a notification of predetermined information (for example, a notification of “being X”) is not limited to being made explicitly, and may be made implicitly (for example, a notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for exemplification, and does not have any restrictive meaning with respect to the present disclosure.

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called other names.

Further, software, instructions, and the like may be transmitted and received via a transmission medium. For example, when software is transmitted from a website, a server, or another remote source using a wired technology such as a coaxial cable, an optical fiber cable, a twisted pair, or a digital subscriber line (DSL) and/or a wireless technology such as infrared rays, radios, or microwaves, the wired technology and/or the wireless technology is included in the definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or any combination of these.

The terms described in the present disclosure and/or terms necessary for understanding of the present specification may be replaced by terms having the same or similar meanings.

The terms “system” and “network” used in the present specification are used interchangeably.

Further, information, parameters, and the like described in the present specification may be represented by an absolute value, may be represented by a relative value from a predetermined value, or may be represented by corresponding different information.

The term “determining” used in the present disclosure may include a variety of operations. The “determining” can include, for example, regarding judging, calculating, computing, processing, deriving, investigating, searching (looking up, search, or inquiry) (for example, searching in a table, a database, or another data structure), or ascertaining as “determining”. Further, “determining” can include regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing or the like as “determining”. That is, “determining” can include regarding a certain operation as “determining”. Further, “determination” may be read as “assuming”, “expecting”, “considering”, or the like.

The description “based on” used in the present disclosure does not mean “based only on” unless otherwise noted. In other words, the description “based on” means both of “based only on” and “at least based on”.

When the terms “first”, “second”, and the like are used in the present specification, any reference to elements thereof does not generally limit an amount or order of those elements. These terms can be used in the present specification as a convenient way to distinguish between two or more elements. Thus, the reference to the first and second elements does not mean that only two elements can be adopted or that the first element has to precede the second element in some way.

When “include”, “including” and modifications thereof are used in the present specification or claims, those terms are intended to be comprehensive like the term “comprising”. Further, the term “or” used in the present specification or claims is intended not to be an exclusive OR.

In the present specification, it is assumed that a plurality of devices are also included unless a single device is clearly indicated by the context or technically.

In the whole of the present disclosure, it is assumed that a plurality of things are included unless it is not cleared from the context that a singular thing is indicated.

### REFERENCE SIGNS LIST

10 Scoring model learning device
11 Concatenation sentence generation unit
12 Learning data generation unit
13 Division unit
14 Prediction unit
15 Model learning unit
20 Determination device
21 Question sentence output unit
22 Answer concatenation unit
23 Answer division unit
24 Determination unit
25 Output unit
30 Learning data storage unit
40 Scoring model storage unit
50 Question sentence storage unit
cv Context vector generation unit
m10 Main module
m11 Concatenation sentence generation module
m12 Learning data generation module
m13 Division module
m14 Prediction module
m15 Model learning module
M1A Recording medium
M1B Recording medium
m20 Main module
m21 Question sentence output module
m22 Answer concatenation module
m23 Answer division module
m24 Determination module
m25 Output module
MD Scoring model
P1A Scoring model learning program
P1B Determination program
RN, RN1, RN2 Recurrent neural network
sm Likelihood calculation unit

1. A scoring model learning device for generating a scoring model for determining naturalness of an answer sentence to a question sentence through machine learning,
wherein the scoring model includes a recurrent neural network, a context vector generation unit configured to synthesize hidden vectors output by a hidden layer in respective time steps of the recurrent neural network to generate a context vector, and a likelihood calculation unit configured to calculate a likelihood of a label indicating at least naturalness of the answer sentence to the question sentence on the basis of the context vector, and
the scoring model learning device comprises circuitry configured to:
divide a concatenation sentence included in learning data including a pair of the concatenation sentence having the question sentence and the answer sentence concatenated with each other and a correct answer label indicating naturalness as an answer to the question sentence of the answer sentence into words to generate a word string;
input each word included in the word string to the recurrent neural network of the scoring model according to an arrangement order and acquire the likelihood calculated by the likelihood calculation unit; and
update parameters of the recurrent neural network on the basis of an error between the likelihood acquired by the circuitry and the correct answer label.

2. The scoring model learning device according to claim 1, wherein the circuitry is further configured to:
concatenate the question sentence and the answer sentence to the question sentence to generate the concatenation sentence; and
generate the learning data including a pair of a concatenation sentence and a correct answer label indicating the naturalness as an answer to the question sentence of the answer sentence included in the concatenation sentence.

3. The scoring model learning device according to claim 2, wherein the circuitry inserts a delimiter token indicating a delimiter of a sentence between the question sentence and the answer sentence to generate the concatenation sentence.

4. The scoring model learning device according to claim 1,
wherein the context vector generation unit of the scoring model weights and synthesizes the hidden vectors output from the hidden layer in the respective time steps of the recurrent neural network to generate the context vector, and
the circuitry updates the parameters of the recurrent neural network and the weight on the basis of the error between the likelihood acquired by the circuitry and the correct answer label.

5. The scoring model learning device according to claim 1, wherein the circuitry updates the parameters of the hidden layer of the recurrent neural network on the basis of an error between a word predicted on the basis of a hidden vector obtained by inputting an m-th word among a plurality of words included in the word string to the hidden layer of the recurrent neural network and a (m+1)-th word, the (m+1)-th word being a word next to the m-th word in the word string, in a m-th (m is an integer equal to or greater than 2) time step.

6. The scoring model learning device according to claim 1,
wherein the recurrent neural network is a bidirectional recurrent neural network, and
the hidden layer outputs a hidden vector in the n-th time step on the basis of a word input in an n-th (n is an integer equal to or greater than 2) time step, a hidden vector output in an (n+1)-th time step, and a hidden vector output in an (n−1)-th time step, in the n-th time step.

7. The scoring model learning device according to claim 1, wherein the recurrent neural network is a long short term memory (LSTM) network or a gated recurrent unit (GRU) network.

8-9. (canceled)

10. A determination device for determining naturalness of an answer sentence with respect to a question sentence, the determination device comprising circuitry configured to:
concatenate the answer sentence input with respect to the question sentence with the question sentence to generate a concatenated answer sentence;
divide the concatenated answer sentence into words to generate an answer word string;
input words included in the answer word string to a scoring model including a recurrent neural network in an arrangement order and acquire a likelihood indicating at least the naturalness of the answer sentence; and
output a determination result based on the likelihood acquired by the circuitry,
wherein the scoring model is a learned model based on machine learning for causing a computer to function, and includes
the recurrent neural network;
a context vector generation unit configured to synthesize hidden vectors output by a hidden layer in respective time steps of the recurrent neural network to generate a context vector; and
a likelihood calculation unit configured to calculate a likelihood of a label indicating at least naturalness of the answer sentence to the question sentence on the basis of the context vector,
wherein words in a word string generated by dividing a concatenation sentence having the question sentence and the answer sentence concatenated with each other are used as inputs in each time step of the recurrent neural network, and
wherein the scoring model is constructed by machine learning for updating parameters of the recurrent neural network on the basis of an error between the likelihood calculated by the likelihood calculation unit by using a pair of a concatenation sentence and a correct answer label indicating naturalness as an answer to the question sentence of the answer sentence included in the concatenation sentence as learning data and inputting the word string generated on the basis of the concatenation sentence included in the learning data to the recurrent neural network and the correct answer label included in the learning data.

11. The scoring model learning device according to claim 2,
wherein the context vector generation unit of the scoring model weights and synthesizes the hidden vectors output from the hidden layer in the respective time steps of the recurrent neural network to generate the context vector, and
the circuitry updates the parameters of the recurrent neural network and the weight on the basis of the error between the likelihood acquired by the circuitry and the correct answer label.

12. The scoring model learning device according to claim 3,
wherein the context vector generation unit of the scoring model weights and synthesizes the hidden vectors output from the hidden layer in the respective time steps of the recurrent neural network to generate the context vector, and
the circuitry updates the parameters of the recurrent neural network and the weight on the basis of the error between the likelihood acquired by the circuitry and the correct answer label.
